(19) United States
(12) Patent Application Publication
(10) Pub. No.: US 2004/0041073 A1
(43) Pub. Date: Mar. 4, 2004

(54) Dental mold and method of producing a dental mold

(75) Inventor: Akihiro Kuroiwa, Nagano (JP)

Correspondence Address: FOLEY AND LARDNER, SUITE 500, 3000 K STREET NW, WASHINGTON, DC, 20007, US

(73) Assignee: MATSUMOTO DENTAL UNIVERSITY

(21) Appl. No.: 10/437,428

(22) Filed: May 14, 2003

(30) Foreign Application Priority Data
May 15, 2002 (JP) 2002-139479

(51) Int. Cl. B28B 7/00

(52) U.S. Cl. 249/117

(57) ABSTRACT

A dental mold is formed using, as a material, a mold material that formed a first mold having a first mold surface, and has a second mold surface different from the first mold surface. Alternatively, the material of the mold material contains powder after use obtained by grinding the first mold, and new powder added to the powder after use. The mold material is a quick heating type gypsum bonded mold material, and contains 1% of at least a gypsum. Alternatively, the mold material uses a gypsum at 25 to 45% and at least one of quartz and cristobalite at 55 to 75%. Further, the mold material contains one of chloride and alum as an additive.

This application claims priority to prior application JP 2002-139479, the disclosure of which is incorporated herein by reference.

### BACKGROUND OF THE INVENTION

The present invention belongs to a dental mold obtained by recycling a mold material of a mold after use, and a method of producing a dental mold obtained by recycling the mold material.

Conventionally, in the dental field, crown prostheses and restorations such as crowns, bridges, inlays, and metal framework have been used upon performing crown prosthesis or crownwork, and restoration. Crown prostheses and restorations are required to be adapted to patients' teeth that individually have different shapes. Therefore, the crown prostheses and restorations are precisely produced by the use of the lost-wax technique.

The lost-wax technique is a producing method wherein a wax material (brazing material) is formed into a wax pattern (wax model) and, after filling a mold material around the wax pattern, the wax material is heated to flow out, thereby producing a casting mold.

Those casting molds produced by the lost-wax technique are discarded as industrial waste after use. The casting molds after use, when buried in the ground as the industrial waste, become aqueous solutions due to rainwater etc. so as to flow out, and thus there is a problem of the possibility of environmental pollution and ecosystem destruction. Producers concerned with the casting molds are required to make efforts to reduce the waste irrespective of the industrial field or the medical field.

### SUMMARY OF THE INVENTION

Therefore, it is an object of the present invention to provide a casting mold and a method of producing the casting mold, which can reduce the waste by recycling a material of a casting mold after use, for the purpose of constructing a system that does not pollute environment or destruct ecosystem.

According to one aspect of the present invention, there is obtained a dental mold which is formed using, as a material, a mold material that forms a first mold having a first mold surface, and which has a second mold surface different from the first mold surface.

According to another aspect of the present invention, there is obtained a method of producing a dental mold, the method comprising a first step of obtaining powder by grinding a first mold made of a mold material and having a first mold surface, and a second step of forming a second mold having a second mold surface different from the first mold surface, using the powder.

### BRIEF DESCRIPTION OF THE DRAWINGS

FIG. 1 is an explanatory diagram showing a process in the course of producing a dental mold using a mold material, with respect to a dental mold according to the present invention.

FIG. 2 is a graph for explaining influence of addition of powder after use that is exerted upon a setting time.

FIG. 3 is a graph for explaining influence of addition of powder after use that is exerted upon a fitness of castings.

### DESCRIPTION OF THE PREFERRED EMBODIMENTS

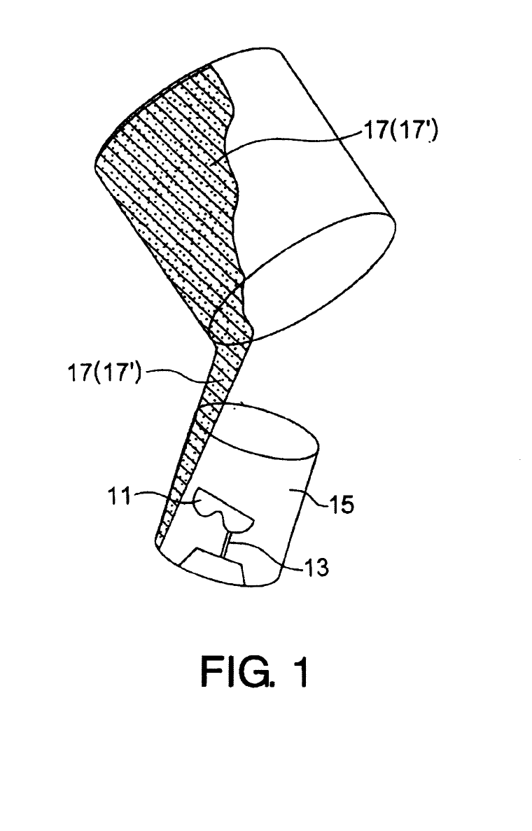

Hereinbelow, a dental mold and a method of producing the dental mold, according to the present invention, will be described with reference to the drawings. FIG. 1 shows an embodiment of the present invention and illustrates a step during production of a dental mold using a mold material.

Referring to FIG. 1, a dental mold according to a first example is formed using as a material a mold material 17 that formed a first mold having a first mold surface, and has a second mold surface different from the first mold surface.

The mold material 17 is a quick heating type gypsum bonded mold material and contains 1% of at least a gypsum. The mold material 17 forming the first mold is made of powder, and the particle size of the powder is within a range of 60 mesh to 300 mesh.

The mold material 17 may also be made of 25 to 45% a gypsum and 55 to 75% of at least one of quartz and cristobalite. The mold material 17 may also contain, as an additive, one of chloride and alum made of one kind of NaCl, KCl and the like. An added amount of the additive is set to 0.01 to 35%.

In case where both chloride and alum are added as additives, it is desirable to add them so that the ratio of chloride and alum is about 1:2 assuming that the whole of chloride and alum is 100%.

Incidentally, the mold material 17 is called a quartz mold material when quartz is in the majority, and is called a cristobalite mold material when cristobalite is in the majority.

A dental mold according to a second example contains, as a material of a mold material 17′, powder after use obtained by grinding a first mold, and new powder added to the powder after use. The powder after use and the new powder are made of a quick heating type gypsum bonded mold material.

The mold material 17′ contains 1% of at least a gypsum. The particle sizes of the powder after use and the new powder are within a range of 60 mesh to 300 mesh.

The mold material 17′ may also be made of 25 to 45% a gypsum and 55 to 75% of at least one of quartz and cristobalite. The mold material 17 may also contain, as an additive, one of chloride and alum made of one kind of NaCl, KCl and the like. An added amount of the additive is set to 0.01 to 35%.

In case where both chloride and alum are added as additives, it is desirable to add them so that the ratio of chloride and alum is about 1:2 assuming that the whole of chloride and alum is 100%.

Next, referring to FIG. 1, a method of producing the dental mold in the first example will be described.

The dental mold is made of the mold material 17 and includes a first step of obtaining the powder by grinding the first mold having the first mold surface, and a second step of forming the second mold having the second mold surface different from the first mold surface, by the use of the powder. As the first mold, a mold made of the quick heating type gypsum bonded mold material is used.

The second step includes a step of forming a wax pattern 11 from a wax material, a step of forming the second mold from the powder around the wax pattern 11, and a step of heating the wax pattern 11 to flow out the wax material from the second mold.

In the step of forming the wax pattern 11, the wax pattern 11 is produced using the wax material. The wax pattern 11 is provided with a gate portion 13. Then, the wax pattern 11 is put into a ring (frame) 15.

In the step of forming the second mold, the powder obtained by grinding the first mold is kneaded with water to thereby obtain the mold material 17 in the form of paste. The mold material 17 in the form of paste is placed around the wax pattern 11 in the ring 15, and solidified at room temperature.

The wax pattern 11 is burned out and melted out (dewaxing) through heating at a temperature of about 100° C. Thereafter, the residual wax pattern 11 is incinerated by raising the temperature to about 650 to 750° C., thereby to obtain the second mold.

When the additive is added to the mold material 17, it sets in 20 to 30 minutes until the added amount reaches 70%. Thereafter, the mold material 17 is thrown into an electric furnace and cast at a temperature of 650 to 750° C.

Metal melt not shown is poured (cast) into a portion where the wax pattern 11 is incinerated, and the metal is taken out from the second mold, to thereby obtain a cast object.

Next, referring to FIG. 1, a method of producing the dental mold in the second example will be described.

The dental mold is made of the mold material 17′. A portion of the step of forming the second mold differs from the method described in the first example.

Specifically, the step of forming the second mold includes adding the new powder made of the quick heating type gypsum bonded mold material to the powder of the used-mold material 17. The particle size of the new powder is within the range of 60 mesh to 300 mesh.

Other steps and materials are same as those used in the method of producing the dental mold in the first example.

Hereinbelow, results of measurements of the setting time, the compressive strength, the fitness of castings, and the heating expansion and the setting expansion amount of the mold are shown with respect to the mold materials according to the present invention.

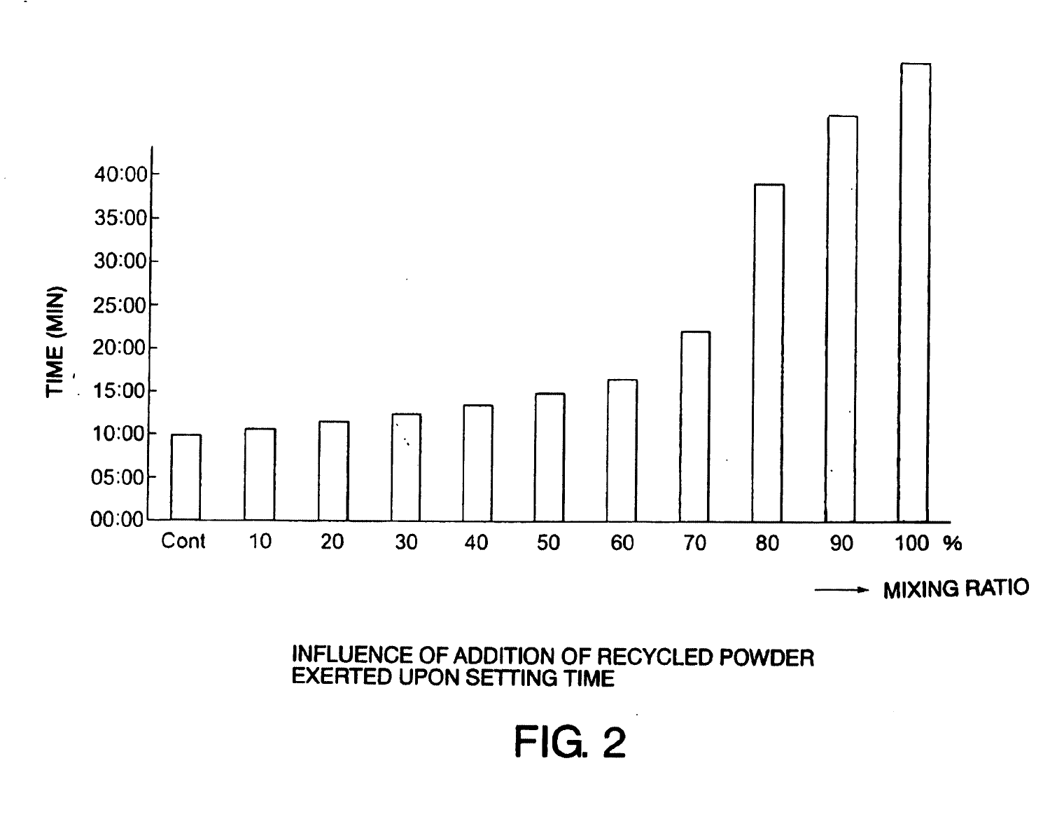

FIG. 2 shows influence of the addition of the powder of the used-mold material 17 (the powder after use) exerted upon a setting time in terms of time (minute) and mixing ratio (%).

As is clear from FIG. 2, when the powder after use was contained at 90% to 100%, the result was obtained that the setting time was as long as 40 minutes or more. In case of a mixture of 80% of the powder after use and 20% of the new powder, or in case of a mixture obtained by adding a gypsum and at least one kind of chloride and alum to the mold material 17, 17′, the setting time is about 35 minutes.

The setting time obtained by Cont (Control) which is a mold material using only the new powder as shown in FIG. 2 is about 10 minutes. As compared with Cont, even the mold material added with 80% of the powder after use is fully usable. Inasmuch as the expansion amount is reduced in case of inclusion of 80 to 100% of the powder after use, an excellent fitness of castings is obtained when an inlay, a core or the like is cast using a dental silver alloy with small casting contraction.

Comparing the compressive strength with Cont shown in FIG. 2, those mold materials added with the powder after use are fully usable. In this connection, the compressive strength of the mold material without using the powder after use was about 3.5 MPa. The compressive strength was about 4.5 MPa when the powder after use was added at 10%, about 4.0 MPa at 20%, about 4.0 MPa at 30%, about 3.8 MPa at 50%, about 3.5 MPa at 60%, about 3.2 MPa at 60 %, and about 3.0 MPa at 80%.

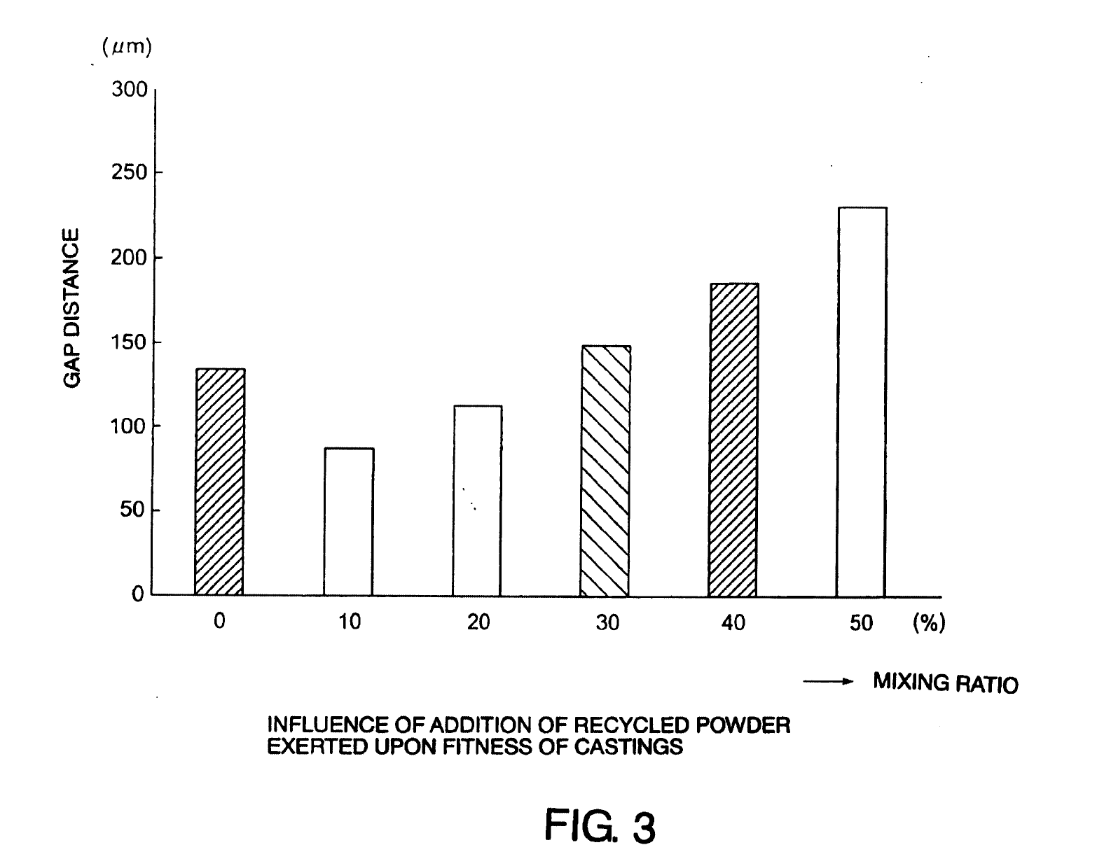

FIG. 3 shows influence of the addition of the powder after use that is exerted upon a fitness of castings in terms of fitness of castings (μm) and mixing ratio (%).

As is clear from FIG. 3, the fitness of castings of the unused mold material is such that the gap distance (μm) is about 130 μm. The gap distance is about 80 μm when the powder after use is added at 10%, about 110.4 μm at 20%, about 147.24 μm at 30%, about 185.2 μm at 40%, and about 229.0 μm at 50%. Here, the fitness of castings is improved by adding the powder after use at 40%.

With respect to the heating expansion and the setting expansion amount of the mold, the expansion amount of the mold material without using the powder after use is about 1.5%. The expansion amount is about 1.67% when the powder after use is added at about 10%, about 1.71% at 20%, about 1.87% at 40%, about 1.78% at 50%, about 1.70% at 60%, and about 1.62% at 70%. The heating expansion and the setting expansion became the largest when the powder after use was added at 40%.

Therefore, when the powder after use is added at 10 to 30%, the expansion coefficient of the mold is improved. From this, when the powder after use is added at 10% to 30%, more fittable castings are obtained as compared with the use of an ordinary mold. Further, because no rapid degradation in expansion occurs even at higher ratios, a mold suitable for a cast crown is obtained up to 40% of the powder after use. A mold suitable for a dental silver alloy for casting an inlay or a metal core is obtained at 80% to 100% of the powder after use.

While the dental mold has been described in conjunction with the present invention, it is needless to say that this invention is also applicable to a mold for producing a ring, a brooch or the like in jewelry.

What is claimed is:

1. A dental mold which is formed using, as a material, a mold material that forms a first mold having a first mold surface, and which has a second mold surface different from said first mold surface.

2. A dental mold according to claim 1, wherein said mold material is a quick heating type gypsum bonded mold material.

3. A dental mold according to claim 1, wherein said mold material contains 1% of at least a gypsum.

4. A dental mold according to claim 1, wherein said mold material comprises 25 to 45% a gypsum and 55 to 75% of at least one of quartz and cristobalite.

5. A dental mold according to claim 2, wherein said mold material contains one of chloride and alum as an additive.

6. A dental mold according to claim 5, wherein an added amount of said additive is 0.01 to 35%.

7. A dental mold according to claim 1, wherein the dental mold is made of powder of said mold material, and a particle size of said powder is within a range of 60 mesh to 300 mesh.

8. A dental mold according to claim 1, wherein said material contains powder after use obtained by grinding said first mold, and new powder added to said powder after use and made of a quick heating type gypsum bonded mold material.

9. A dental mold according to claim 8, wherein a particle size of said new powder is within a range of 60 mesh to 300 mesh.

10. A method of producing a dental mold, the method comprising a first step of obtaining powder by grinding a first mold made of a mold material and having a first mold surface, and a second step of forming a second mold having a second mold surface different from said first mold surface, using said powder.

11. A method according to claim 10, wherein a mold made of a quick heating type gypsum bonded mold material is used as said first mold.

12. A method according to claim 10, wherein said second step includes a step of forming a wax pattern from a wax material, a step of forming said second mold from said powder around said wax pattern, and a step of heating said wax pattern to flow out said wax material from said second mold.

13. A method according to claim 12, wherein the step of forming said second mold includes kneading said powder with water to obtain paste, and placing said paste around said wax pattern and solidifying it.

14. A method according to claim 10, wherein a mold containing 1% of at least a gypsum is used as said first mold.

15. A method according to claim 10, wherein a material comprising 25 to 45% a gypsum and 55 to 75% of at least one of quartz and cristobalite is used as said mold material.

16. A method according to claim 11, wherein a material containing one of chloride and alum as an additive is used as said mold material.

17. A method according to claim 16, wherein an added amount of said additive is 0.01 to 35%.

18. A method according to claim 10, wherein a particle size of said powder is within a range of 60 mesh to 300 mesh.

19. A method according to claim 10, wherein said second step includes adding new powder made of a quick heating type gypsum bonded mold material, to said powder.

20. A method according to claim 19, wherein a particle size of said new powder is within a range of 60 mesh to 300 mesh.
